(19) United States
(12) Patent Application Publication
(10) Pub. No.: US 2025/0117681 A1
(43) Pub. Date: Apr. 10, 2025

(54) Online Calibration of Qubits During Quantum Computation Runtime

(71) Applicant: Google LLC, Mountain View, CA (US)

(72) Inventor: Nathan Cody JONES, Los Angeles, CA (US)

(21) Appl. No.: 18/481,042

(22) Filed: Oct. 4, 2023

(51) Int. Cl. G06N 10/60; G06N 10/70

(52) U.S. Cl. CPC G06N 10/40

(57) ABSTRACT

This disclosure is directed to a method for performing a quantum computation. A set of qubits may be allocated for the quantum computation. The qubits of the set of the qubits may be calibrated in parallel with the execution of the quantum computation. The method may include subdividing the set of qubits into a first calibration group and a first computation group. The first calibration group and the first computation group may be complementary subsets of the set of qubits. A first portion of the quantum computation may be executed with qubits included in the first computation group. During execution of the first portion of the quantum computation with the qubits included in the first computation group, qubits included in the first calibration group may be calibrated. A second portion of the quantum computation may be executed with the calibrated qubits included in the first calibration group.

### FIELD

The present disclosure relates generally to quantum computing systems, and more particularly to the online calibration of qubits during a quantum computation runtime.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b |1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for performing a quantum computation. A set of qubits may be allocated for the quantum computation. The qubits of the set of the qubits may be calibrated in parallel with the execution of the quantum computation. The method may include subdividing the set of qubits into a first calibration group and a first computation group. The first calibration group and the first computation group may be complementary subsets of the set of qubits. A first portion of the quantum computation may be executed with qubits included in the first computation group. During execution of the first portion of the quantum computation with the qubits included in the first computation group, qubits included in the first calibration group may be calibrated. A second portion of the quantum computation may be executed with the calibrated qubits included in the first calibration group.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2 depicts a process 200 for the online calibration of qubits performed in parallel with an execution of a quantum computation by a quantum computing system, according to various embodiments.

FIG. 3 depicts multiple steps of a single stage 300 of process 200 of FIG. 2, according to various embodiments.

FIGS. 4-12 depicts modified lattice surgery operations employed by various embodiments.

FIG. 13 depicts a flow chart diagram of an example method 1300 performing a quantum computation, while calibrating qubits, according to example embodiments of the present disclosure.

### DETAILED DESCRIPTION

Example aspects of the present disclosure are directed to enhanced systems and methods for the online calibration of qubits during a quantum computation runtime. The basic unit of computation within a quantum computer is a qubit (e.g., contrasted with bits of a classical digital computer). For sufficient computational fidelity, the qubits of a quantum computer must be calibrated via system parameters. The “lifetime” of a calibration of a qubit is finite. The execution of many quantum algorithms (e.g., quantum computations) often require longer periods of time than the lifetime of calibration for a qubit. That is, if a qubit is calibrated at the start of the execution of a quantum algorithm, by the time the execution is finished, the qubit may have shifted out of calibration, rendering inaccurate and degraded results of the computation (e.g., computational errors).

This problem is worsened by the fact that, due to the sensitive nature of coherent quantum states of a single physical qubit, quantum error correction (QEC) codes are often implemented to execute a quantum computation. Although the details of QEC codes vary, most QEC codes employ the concept of a logical qubit. In these QEC codes, a plurality of physical qubits is employed to form a logical qubit that redundantly encodes the information that is, in theory, encodable via a single (and error-free) physical qubit. However, since single physical qubits are not error-free, in an analogous fashion to classical error codes, quantum computers employ logical qubits to implement informational redundancy. It is this informational redundancy that enables both the detection and correction of quantum errors (e.g., both X-type and Z-type errors) in the logical qubit. Furthermore, the logical qubit is comprised of a plurality of “data” qubits and “measure” qubits. Data qubits redundantly encode the information for computation, while measure qubits are employed to form stabilizers. Via stabilizer operations and measurements (e.g., syndrome measurements), errors in the data qubits and measure qubits can be detected without collapsing the coherent quantum states of the data qubits. Furthermore, in QEC codes such as but not limited to topological surface codes, lattice surgery operations enable the correction of the detected quantum errors, as well as the implementation of multi qubit logic gates (e.g., a CNOT operation).

However, QEC codes require operational error rates to be sufficiently low in order to function. The implementation of QEC codes typically lengthens the execution-time of the underlying quantum algorithm. As noted above, the physical qubits are subject to drifting system parameters that increasingly degrade performance (e.g., generating additional errors). The various embodiments selectively “turn-off” (e.g., take the qubits offline for computational purposes) sub-populations (or subsets) of qubits during a quantum calibration. The offline qubits are calibrated during the computation. Once calibrated, the qubits are taken back “online” for computation, and another sub-population of qubits (that was previously used for computation) is taken offline for calibration. By cycling the selection of qubits for calibration, the computation via qubits and the calibration of qubits may be performed simultaneously (e.g., in parallel). Thus, a computation of any arbitrary length and complexity may be achieved via qubits that are within whatever calibration tolerances are required by the computing environment. It should be noted that the embodiments are agnostic to methods of calibration. The current “offline” sub-population (e.g., referred to throughout as a calibration group of qubits) may be calibrated by any means that is consistent with the particular implementation of the qubit (e.g., transmon qubits, fluxonium qubit, or the like). Accordingly, the specific details of the calibration of the current calibration group are not discussed herein.

More particularly, the embodiments include the cyclic formation and “splitting” of an “enhanced” logical qubit (e.g., a logical qubit implemented in the context of a QEC code, such as but not limited to a topological surface code), during the simultaneous (and parallel) execution of a quantum computation and a calibration of the qubits employed for the computation. As used herein, an enhanced logical qubit (e.g., an enhanced sized qubit) may be formed by a set of qubits that includes a greater number of both data and measure qubits than is required for the particular implemented QEC code (e.g., a surface code). During the splitting of a logical qubit, a sub-population of qubits (e.g., a qubit calibration group) of the enhanced logical qubit are selected and taken “offline,” with respect to the quantum computation. The other qubits of the enhanced logical qubit (e.g., the ones not included in the calibration group and taken offline) are used to implement a “normal sized” logical qubit as required of the QEC code (e.g., a logical qubit with the correct number of data and measure qubits as dictated by the particulars of the implemented QEC code). The qubits that are employed for the execution of the quantum computation (while the qubits of the calibration group are calibrated) may be referred to as the computation group. That is, the qubits of the computation group form a “normal” sized logical qubit. The qubits of the normal sized logical qubit (e.g., the qubit computation group) is employed for the quantum computation, while the qubits of the calibration group are calibrated. Upon calibration, the calibrated qubits of the calibration group are returned to the enhanced logical qubit. That is, after calibration, the pieces of the enhanced logical qubit are “merged” back together such that the newly calibrated qubits of the calibration are included. After the reformation of the enhanced logical qubit, another (and non-overlapping with respect to the previous calibration group) group of qubits is selected for the calibration group, and the cycle is repeated. In this way, a quantum computation of arbitrary length may be carried out, while the qubits used to execute the computation are cyclically being re-calibrated. Thus, the time required to carry out the computation may be significantly longer than the time period a qubit remains within calibration. Various lattice surgery operations are employed to “split” and “merge” sub-populations of the set of qubits such that the calibration group may be split from the set of qubits and merged back in to the computation group. Lattice surgery operations are also used to merge discontinuous portions of the computation group, such that they may form a logical qubit.

One example aspect of the present disclosure is directed to a method for performing a quantum computation. A set of qubits may be allocated for the quantum computation. The qubits of the set of the qubits may be calibrated in parallel with the execution of the quantum computation. The method may include subdividing the set of qubits into a first calibration group and a first computation group. The first calibration group and the first computation group may be complementary subsets of the set of qubits. A first portion of the quantum computation may be executed with qubits included in the first computation group. During execution of the first portion of the quantum computation with the qubits included in the first computation group, qubits included in the first calibration group may be calibrated. In response to calibrating the qubits included in the first calibration group, the set of qubits may be subdivided into a second calibration group and a second computation group. The second calibration group and the second computation group may be complementary subsets of the set of qubits. The second computation group may include the calibrated qubits included in the first calibration group. A second portion of the quantum computation may be executed with qubits included in the second computation group. During execution of the second portion of the quantum computation with the qubits included in the second computation group, qubits included in the second calibration group may be calibrated.

I should be noted that specific operations are discussed throughout, with respect to X-basis and Z-basis operations and measurements. However, it should be noted that due to symmetry considerations, the specific operations may be swapped. For example, any X-basis operation/measurement discussed herein may be swapped with a corresponding Z-basis operation/measurement. Likewise, a the corresponding Z-basis operation/measurement may be swapped with an X-basis operation/measurement. For instance, is a basis-swap implementation, measuring and resetting in the Z-basis would corresponds to (in a basis swap) would mean measuring a 0/1 and resetting the qubit to a 0 state, instead of measuring and resetting in the X-basis. The embodiments may also be generalized to the “XZZX” basis codes by labeling the stabilizers as “X” or “Z” in an alternating checkerboard fashion. Similar to the symmetry discussed above, the reset and measurement basis follows the relevant logical operator as X or Z on each physical qubit.

Aspects of the present disclosure provide a number of technical effects and benefits. For instance, the methods and systems presented herein a parallelization of a quantum computation and a calibration of the qubits employed for the quantum computation. More specifically, a first portion of the qubits are calibrated while another portion of the qubits are employed to execute a first portion of the computation. After the first portion of the qubits are calibrated a second portion of the qubits are calibrated, while another portion of the qubits (including the calibrated first portion) are employed to execute a second portion of the computation. In this way, a quantum computation of any arbitrary length (e.g., a computation that takes longer to execute than a lifetime for the calibration of any individual qubit) may be carried out, while keeping the qubits within calibration. Accordingly, quantum computations of arbitrary length may be carried out, without the qubits going out of calibration.

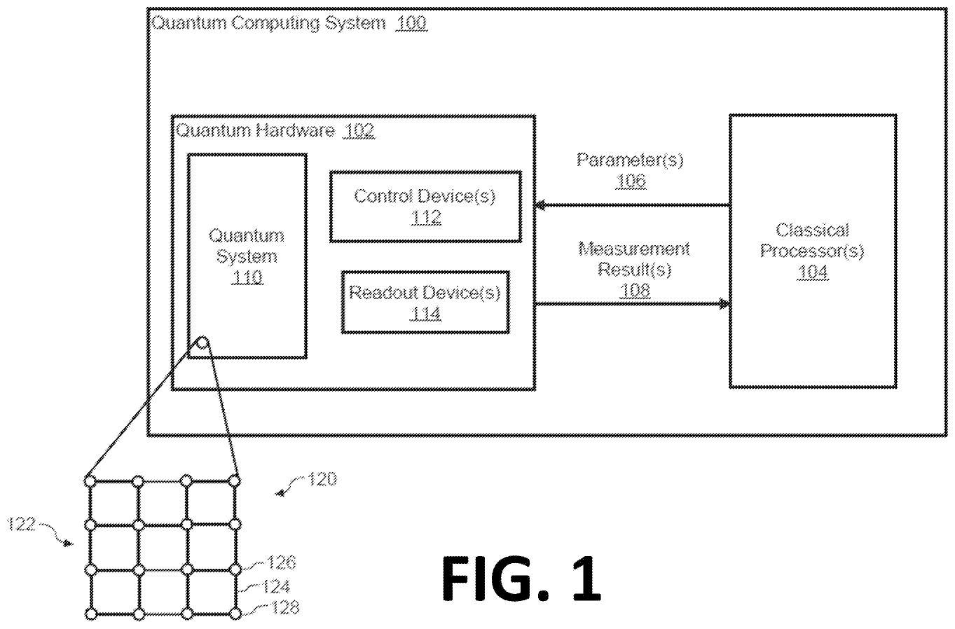

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

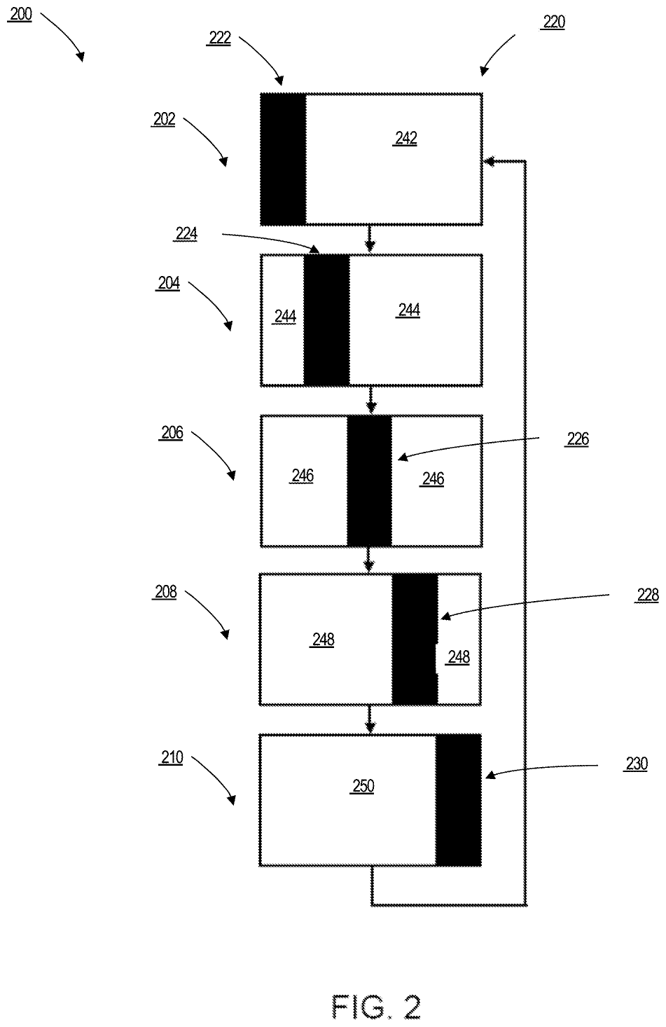

FIG. 2 depicts a process 200 for the online calibration of qubits performed in parallel with an execution of a quantum computation by a quantum computing system, according to various embodiments. In FIG. 2, a set of qubits 220 may be allocated for the quantum computation. The rectangle representing the set of qubits 220 is intended to illustrate a “patch” of qubits arranged in a 2D fashion (e.g., a 2D grid or 2D lattice of qubits). Note that individual qubits of the set of qubits 220 are not illustrated in FIG. 2, but rather the 2D rectangle represents a “boundary” of a patch of qubits, where the patch is comprised of a 2D grid of physical qubits and the boundary of the 2D grid is illustrated by the rectangle. Process 200 may be run in parallel with the execution of the quantum computation. Although individual qubits are not illustrated in FIG. 2, the qubits of the set of qubits 220 may be arranged in a set of rows and columns of qubits (e.g., a 2D grid or lattice or qubits). The set of qubits 200 may form an enhanced logical qubit in a quantum error correction (QEC) code, such as but not limited to a topological surface code. Accordingly, the set of qubits 220 may be referred to as a surface code patch or a unified surface code. To form an enhanced logical qubit, the set of qubits 220 may be comprised of a set of data qubits and a set of measure qubits (e.g., a set of syndrome measure qubits and/or a set of stabilizer qubits).

As noted above, an enhanced logical qubit (e.g., an enhanced sized qubit) may be formed by a set of qubits (e.g., the set of qubits 220) that includes a greater number of both data and measure qubits than is required for the particular implemented QEC code (e.g., a topological surface code). An enhanced qubit may be referred to as a “unified surface code” throughout. An enhanced logical qubit is contrasted with a normal (e.g., a normal-sized) logical qubit, which does not include the “extra” data and/or extra measure qubits. A normal-sized logical qubit may be referred to simply as a logical qubit. As described below, the qubits of the set of qubits 220 may be subdivided into two non-overlapping groups or subsets of qubits: a calibration group and a computation group. The computation group is employed to form a normal-sized logical qubit (e.g., a logical qubit), while the calibration group is taken “offline” for computational purposes, and calibrated. While the calibration group is being calibrated, the two or more computation groups form the normal sized logical qubit, where the normal-sized logical qubit is used to perform at least a portion of the computation. As shown in FIG. 2, process 200 is cyclical, and the calibration group is “moved” throughout the execution of the computation, such that different combinations of the qubits form the computation group (e.g., the logical qubit) used for the computation (e.g., in parallel with process 200 and the calibration of the qubits of the separate calibration groups). That is, different combinations of the qubits of the set of qubits 220 are employed to form different computations groups that are used to execute separate portions of the quantum computation, while a separate calibration group is taken offline at each stage of process 200 for calibration purposes.

As such, the set of qubits 220 may include more qubits than is needed for a single logical qubit. For instance, in a typical surface code, a logical qubit may be formed from equal numbers of rows of data qubits and columns of data qubits. As shown in FIG. 2, the set of qubits 220 may include additional columns of data qubits (and additional columns of measure qubits), as compared to the rows of data qubits (and rows of measure qubits). In other embodiments, the set of qubits 220 includes additional rows of data qubits (and additional rows of measure qubits), as compared to the columns of data qubits (and columns of measure qubits). That is, a 2D rectangle (rather than a square) is used to represent the set of qubits in FIG. 2. In the non-limiting embodiments of FIG. 2, the set of qubits 220 includes an additional 20% more columns of both data and measure qubits than is required in the surface code that is implemented via process 200. In other embodiments, the number of additional columns (or rows) of qubits may vary. Process 200 is a cyclic process with a number of stages in a single iteration of the cycle of process 200. The percentage of extra qubits included in the set of qubits 220 indicates the number of stages in the cycles of process 200.

The non-limiting embodiment of process 200 includes 5 stages (e.g., indicated by the 20% extra number of columns of qubits in the set of qubits): first stage 202, second stage 205, third stage 206, fourth stage 208, and fifth stage 210. As shown by the return arrow in FIG. 2, after performance of the fifth stage 210, cyclic process 200 returns to the first stage 202. Other embodiments may include more or less numbers of stages per cycle. In various embodiments, the number of stages in process 200 corresponds to the number of additional qubits included in the set of qubits 220. For instance, because 20% additional qubits are included in the set of qubits 220, (e.g., 20% more qubits than is required for the logical qubit implemented by the set of qubits 220), process 200 includes five stages. As noted throughout, other embodiments may vary in the number of additional qubits included in the set of qubits 220, the number of stages in the cycling process 200, and whether the additional qubits are arranged in rows or columns of the 2D grid (or lattice) of qubits.

Prior to initiating process 200, the set of qubits 220 may be subdivided into N non-overlapping subsets of qubits to form a set of qubit groups, where N is a positive integer greater than 1. In the non-limiting embodiment of FIG. 2, N=5. N may also correspond to the number of stages in cyclical process 200, and may vary in the embodiments. Each of the N qubit groups of the set of qubit groups includes one of the N non-overlapping subsets of qubits. In FIG. 2, the qubit groups are indicated by the darkened region in the set of qubits 220, and includes first qubit group 222, second qubit group 224, third qubit group 226, fourth qubit group 228, and fifth qubit group 230. Note that the qubit groups are arranged in groups of rows. In other embodiments, the qubit groups may be arranged in groups of columns. In still other embodiments, the qubit groups may be arranged in other topologies, such as but not limited to groups of rectangular or square “patches” of contiguous qubits. In still other embodiments, the qubit groups may be non-contiguous within the 2D lattice of qubits.

At each stage of process 200, a single qubit group of the set of qubit groups is selected as a calibration group, and the other (N−1) qubit groups form a computation group. In FIG. 2, the calibration group at each stage is indicated by the darkened region in the set of qubits and the computation group is indicated by a lack of shading. Note that the computation group of qubits need not be contiguous. That is, the calibration group may be sandwiched between two (or more) separate qubits groups to form the computation group. In process 200, at each stage, the calibration group is taken offline (or deallocated) for the quantum computation. During that stage, the qubits of the calibration group are calibrated. Also, at that stage, the qubits (both the data and measure qubits) form the logical qubit of the QEC code (e.g., a surface code). Because the set of qubits 220 includes additional (or extra) qubits, there are enough qubits in the computation group to serve as a logical qubit. Accordingly, the qubits of the set of qubits 220 may be periodically calibrated (in stages), without interrupting the execution of the quantum computation. For instance, each group of qubits may be calibrated with a frequency that is equivalent to the frequency of the cycles of process 200.

In the non-limiting embodiment of FIG. 2, during the first stage 202, the first qubit group 222 serves as the calibration group and the second qubit group 224, the third qubit group 226, the fourth qubit group 228, and the fifth qubit group 230 serve as the computation group (e.g., forming an entire logical qubit of the QEC). During the second stage 204, the second qubit group 224 serves as the calibration group and the first qubit group 222, the third qubit group 226, the fourth qubit group 228, and the fifth qubit group 230 serve as the computation group (e.g., forming an entire logical qubit of the QEC). During the third stage 206, the third qubit group 226 serves as the calibration group and the first qubit group 222, the second qubit group 224, the fourth qubit group 228, and the fifth qubit group 230 serve as the computation group (e.g., forming an entire logical qubit of the QEC). During the fourth stage 208, the fourth qubit group 228 serves as the calibration group and the first qubit group 222, the second qubit group 224, the third qubit group 226, and the fifth qubit group 230 serve as the computation group (e.g., forming an entire logical qubit of the QEC). During the fifth stage 210, the fifth qubit group 230 serves as the calibration group and the first qubit group 222, the second qubit group 224, the third qubit group 226, and the fourth qubit group 228 serve as the computation group (e.g., forming an entire logical qubit of the QEC). After the qubits of the fifth qubit group 230 are calibrated during the fifth state 210, process 200 returns to the first stage 202 so that the qubits of the first qubit group 222 may be re-calibrated. Note that the quantum computation may be executed simultaneously (e.g., in parallel with and without interruption) during the cycles of process 200, so that the qubits of the set of qubits 220 remain calibrated throughout the quantum computation. That is, the period of a cycle of process 200 may be shorter than the “lifetime” or “half-life” of a qubit's calibration.

Process 200 may be performed in parallel with performing a quantum computation. The set of qubits 220 may be allocated for the quantum computation. The qubits of the set of the qubits may be calibrated in parallel with the execution of the quantum computation. As noted above, the first stage 202 of process 200 may include subdividing the set of qubits 220 into a first calibration group (e.g., first calibration group 222) and a first computation group (e.g., first calibration group 242). The first calibration group 222 and the first computation group 242 may be complementary subsets of the set of qubits 220. A first portion of the quantum computation may be executed with qubits included in the first computation group 242. During execution of the first portion of the quantum computation with the qubits included in the first computation group 242, qubits included in the first calibration group 222 may be calibrated. In response to calibrating the qubits included in the first calibration group 222, and in the second stage 204 of process 200, the set of qubits may be subdivided into a second calibration group (e.g., second calibration group 224) and a second computation group (e.g., second computation group 244). The second calibration group 224 and the second computation group 244 may be complementary subsets of the set of qubits 220. The second computation group 244 may include the calibrated qubits included in the first calibration group 222. A second portion of the quantum computation may be executed with qubits included in the second computation group 242. During execution of the second portion of the quantum computation with the qubits included in the second computation group 244, qubits included in the second calibration group 224 may be calibrated. As shown in FIG. 2, process 200 may proceed to the third stage 206, then the fourth stage 206, then onto the fifth stage 210, prior to returning to the first stage 202.

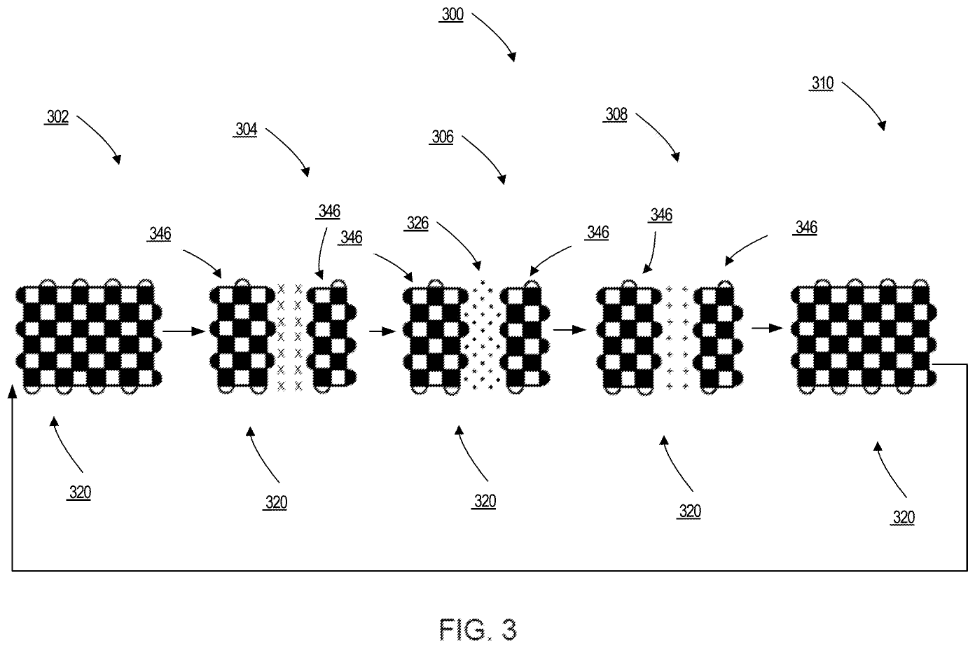

Accordingly, process 200 may be said to be an “evergreen” process, since the qubits are cyclically recalibrated and thus may remain within sufficient calibration tolerances throughout a quantum computation, regardless of the length of the computation. Process 200 is forward compatible with performing lattice surgery simultaneously with qubit calibration. Thus, the qubits of the set of qubits 220 are cyclically calibrated (and re-calibrated) during the quantum computations, via the movement of the calibration group during the stages of process 200. Note that the movement of the calibration group need not be ordered in the way as shown in FIG. 2. For instance, the order of the selection of the qubit group as the calibration group need not be the same as shown in FIG. 2. Each stage of process 200 is comprised of multiple steps. The steps of the stages of process 200 are discussed in conjunction with FIG. 3.

FIG. 3 depicts multiple steps of a single stage 300 of process 200 of FIG. 2, according to various embodiments. Each stage of process 200 may have five steps (or five sub-stages). Stage 300 may correspond to the third stage 206 of process 200. Stage 300 has five steps (or sub-stages): first step 302 of stage 300, second step 304 of stage 300, third step 306 of stage 300, the fourth step 308 of step 300, and the fifth step 310 of stage 300. A set of qubits 320 is shown in each step. The set of qubits 320 of FIG. 3 may be similar to the set of qubits 220 of FIG. 2. As noted above, stage 300 of FIG. 3 may correspond to the third stage 226 of process 200 of FIG. 2. As such, the calibration group of the stage 300 includes the third qubit group 226 of the set of qubits 220 of process 200 and the computation group of the stage 300 includes the first qubit group 222, the second qubit group 224, the fourth qubit group 228, and the fifth qubit group 230 of the set of qubits 220 of process 200. Although only the steps of the third stage 226 of process 200 are shown in FIG. 2 explicitly, these steps may be generalized to the other stages of process 200. The steps of the stage 300 include modified steps of a lattice surgery involving two logical qubits.

In FIG. 3, the details of the 2D grid (or lattice) of the qubits are shown in greater fidelity than in FIG. 2. However, individual qubits of the set of qubits 320 are not shown in the first step 302 and the fifth step 310. Furthermore, in the second step 304 and the fourth step 308, only the data qubits of the calibration group are shown explicitly (e.g., as indicated by Xs or +s respectively). In the third step 306, both the data and the measure qubits of the calibration group are shown explicitly (e.g., as indicated by dots)

The 2D lattice of qubits is arranged in a “checkerboard” pattern of “tiles.” The tiles represent stabilizers of the surface code. In the checkerboard of tiles, some tiles are shaded, and other tiles are not shaded (e.g., non-shaded). The alternating of the shading of the tiles forms a checkerboard on the set of qubits 320. As discussed further below, the two-flavors of shading of the tiles indicates Z stabilizers (shaded tiles) and X stabilizers (non-shaded tiles). In addition to shading, FIG. 3 shows two other additional (and orthogonal to shading) tile-flavors: square tiles and semi-circle tiles on the boundaries of the set of qubits 220. As discussed further below, the square tiles represent weight-4 stabilizers, and the semicircle tiles represent weight-2 stabilizers. Thus, the tiles come in four flavors: (a) shaded and square (e.g., a ZZZZ operator), (b) shaded and semicircle (e.g., a ZZ operator), (c) non-shaded and square (e.g., a XXXX operator), and (d) non-shaded and semicircle (e.g., a XX operator). For the square tiles, a data qubit is placed at the corner of each square tile, while a measure qubit is placed at the center of each square tile. Thus, each square stabilizer (or square tile) of the set of qubits 320 includes 4 data qubits on its corners and a single measure qubit in the center of the square tile (e.g., hence the weight-4 operators, each operator of a weight-4 stabilizer operating on one of the four data qubits). For the semicircle tiles, a data qubit is placed at each terminus of the curved-boundary of the semicircle, while a measure qubit is placed at the center of the curved-boundary of the semicircle. Thus, each semicircle stabilizer (or semicircle tile) of the set of qubits 320 includes 2 data qubits on the terminal ends of the curved-boundary and a single measure qubit on the center of the curve-boundary of the semicircle (e.g., hence the weight-2 operators, each operator of a weight-2 stabilizer operating on one of the two data qubits)

The non-shaded tiles represent X-basis stabilizer's (e.g., XXXX for square tiles and XX for semicircle times), while the shaded tiles represent Z-basis stabilizers (e.g., ZZZ for square tiles and ZZ for semicircle times). Note that a XX or a XXXX operator anti-commutes with an odd number Z errors (e.g., phase-flip errors) on the data qubits, while a ZZ or a ZZZZ operator anti-commutes with an odd number X errors (e.g., bit-flip errors) on the data qubits. A Z operator may induce (as well as correct) a Z error (e.g., a phase-flip error), while an X operator may induce (as well as correct) an X errors (e.g., a bit-flip error).

The first step 302 includes a “unified” surface code, e.g., an enhanced logical qubit comprised of a set of qubits 320. In the second step 304 of stage 300, the data qubits of the corresponding calibration group (e.g., the third qubit group 226 of process 200) are indicated by “Xs” in FIG. 3. More particularly, in the second step 304, the data qubits of the corresponding calibration group of stage 300 are measured in the X-basis. The “Xs” indicate measuring these data qubits in the X-basis. As discussed below, the measurement of the data qubits in the X-basis are used to update the X stabilizers and the X logical observable.

During the third step 306 of the stage 300, the logical qubit is split into two pieces with the qubits of the calibration group 326 indicated by the dots. The calibration group includes both data and the measure qubits, as shown by the dots. In the third step 306, the two separate pieces of checkerboard tiles form a computation group 346. Note that when the calibration group is on an “edge” of the unified surface code, the logical qubit is not split into two pieces because the computation group is comprised on contiguous qubits. More particularly, at the third step 306, the qubits of the calibration group are removed (e.g., deallocated) from the unified surface code. During the third step 306, the removed qubits of the calibration group may be calibrated. Note that the various embodiments may be agnostic to the method of calibration, and any calibration method may be employed for calibrating the qubits of the calibration group.

In the fourth step 308 of stage 300, the data qubits of the calibration group are prepared in the

$$\vert + 〉 = \sqrt{\frac{1}{2}} ( \vert 0 〉 + 1 〉 ) ,$$

as indicated by the “+s” representing the data qubits of the calibration group in the fourth step 308. In the fifth step 310, the surface code is re-unified and the calibrated qubits of the calibration group are returned for use in the quantum computation. The fifth step 310 is returned to the first step 302, and another qubit group may be selected as the calibration group. For instance, the third stage 206 of process 200 may advance to the fourth stage 208 of process 200.

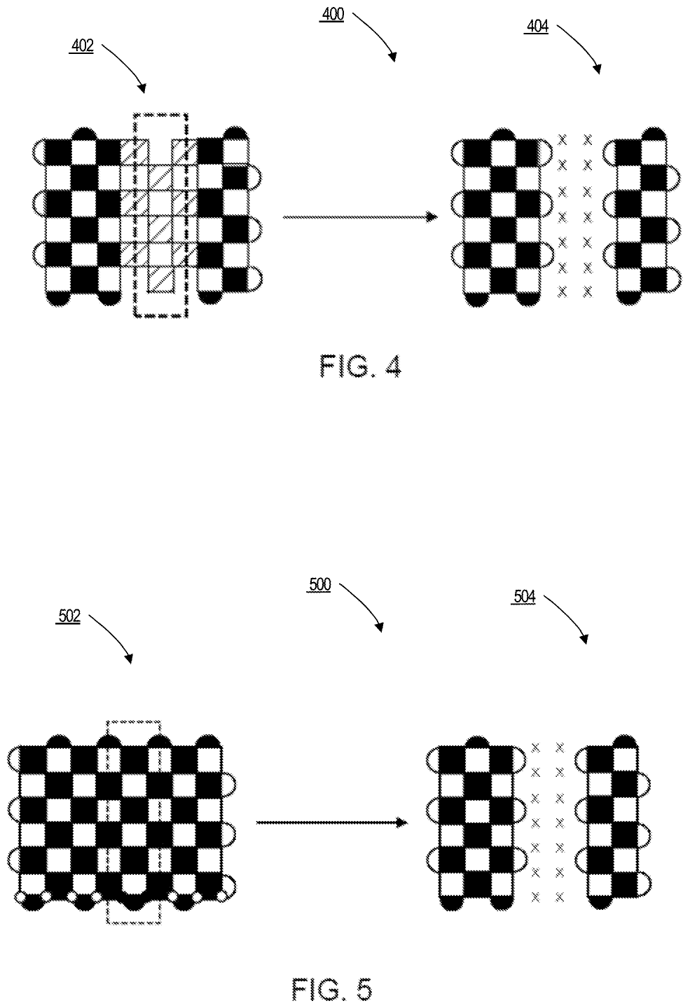

FIG. 4 depicts modified lattice surgery operations employed by various embodiments. More particularly, FIG. 4 shows a first step 402 and a second step 404 of stage 400. Stage 400 may be similar to stage 300 of FIG. 3, first step 402 may be similar to first step 302 of FIG. 3, and second step 404 may be similar to second step 304 of FIG. 3. As noted above, during the second step 404, the data qubits of the calibration group are measured in the X-basis, as indicated by the Xs in the calibration group shown in the second step 404. Note that in the first step 402, the X-checks (e.g., the X-basis stabilizers) in the calibration group are shown with hatched shading, and the Z-check stabilizers (e.g., the Z-basis stabilizers) in the calibration group are shown without shading since they will be removed from the logical qubits in the second step 404. The X-basis measurements of the data qubits in the calibration group enable a final measurement of the XXXX stabilizers (e.g., weight-4 X checks) in the calibration group, prior to their removal from the logical qubit. In various embodiments, the weight-4 X-checks in the calibration group that overlap may be replaced with weight-2 X-checks using the X-basis measurements of the data qubits in the calibration group (or calibration region).

FIG. 5 depicts additional modified lattice surgery operations employed by various embodiments. More particularly, FIG. 5 shows a first step 502 and a second step 504 of stage 500. Stage 500 may be similar to stage 400 of FIG. 4, first step 502 may be similar to first step 402 of FIG. 4, and second step 504 may be similar to second step 404 of FIG. 4. An X-logical observable is shown via the horizontal line of data qubits at the bottom of the logical qubits in the first step 502.

In at least one embodiment, at least some of the weight-4 X-checks in the calibration group are replaced with weight-2 X-checks (e.g., XX operators) rather than being removed. The X-logical observable may be updated via the X-measurements of the data qubits in the calibration group in the second step 504 (as represented by the closed circles along the X-logical observable.

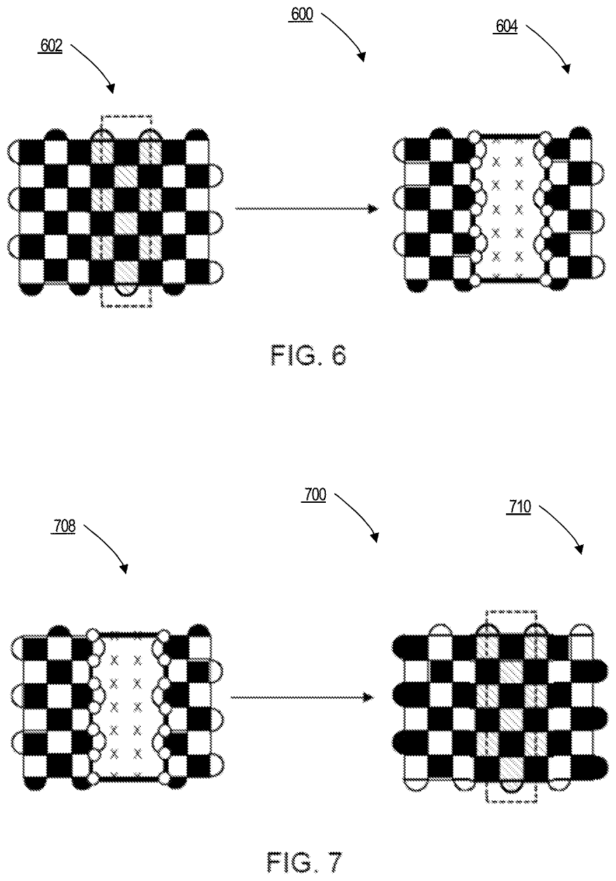

FIG. 6 depicts additional modified lattice surgery operations employed by various embodiments. More particularly, FIG. 6 shows a first step 602 and a second step 604 of stage 600. Stage 600 may be similar to stage 500 of FIG. 5, first step 602 may be similar to first step 502 of FIG. 5, and second step 604 may be similar to second step 504 of FIG. 5. The Z-stabilizer checks are indicated by the open circles(or dots) (e.g., representing data qubits) on the border of the calibration group. The product of all the Z-stabilizer checks is shown via the line connecting the data qubits on the calibration group border.

The X-basis measurements of the data qubits in the calibration group will not commute with the individual Z-basis stabilizer measurements. However, the product of all Z-stabilizer checks will persist, and may be employed to form a latent stabilizer check that is used later (e.g., when going from the fourth step 308 to the fifth step 310 of stage 300 of FIG. 3) to recombine the unified surface code (e.g., the logical qubit pieces).

FIG. 7 depicts additional modified lattice surgery operations employed by various embodiments. More particularly, FIG. 7 shows a fourth step 708 and a fifth step 704 of stage 700. Stage 700 may be similar to stage 300 of FIG. 3 (and/or stage 600 of FIG. 6), fourth step 708 may be similar to fourth step 308 of FIG. 3, and fifth step 710 may be similar to fifth step 504 of FIG. 3. More particular, the persistent product of all Z-stabilizer checks (from the second step 604 of stage 600 of FIG. 6) on the boundary of the calibration region is shown in the fourth step 708. The first round of individual; Z-stabilizer checks may be random in the fourth step 708, but the product of all Z-stabilizer checks may be re-constructed (hence the use of the term persistent).

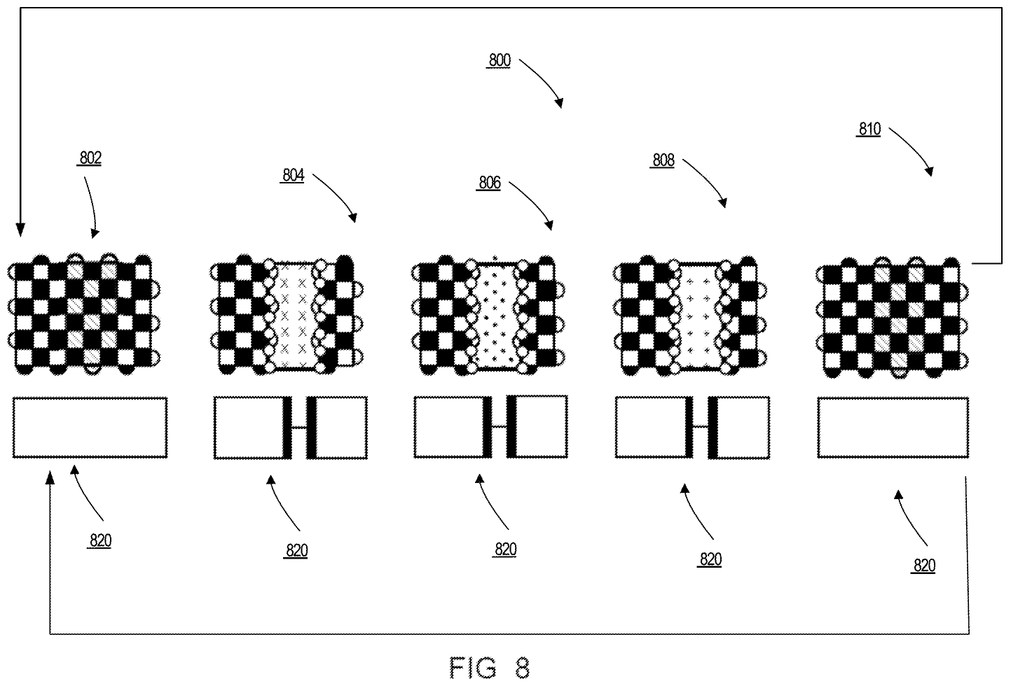

FIG. 8 depicts multiple steps of a single stage 800 of process 200 of FIG. 2, according to various embodiments. Stage 800 may be similar to stage 300 of FIG. 3. As such, stage 800 may be similar to the third stage 206 of process 200 of FIG. 2. Similarly to stage 300 of FIG. 3, stage 800 has five steps (or sub-stages): first step 802 of stage 800, second step 804 of stage 800, third step 806 of stage 800, the fourth step 808 of step 800, and the fifth step 810 of stage 800. First step 802 may be similar to first step 302 of FIG. 3. Second step 804 may be similar to second step 304 of FIG. 3. Third step 806 may be similar to third step 306 of FIG. 3. Fourth step 808 may be similar to fourth step 308 of FIG. 3. Fifth step 810 may be similar to fifth step 310 of FIG. 3.

Below each of the five steps, a corresponding enhanced logical qubit 820 is shown below the step. The arrows on FIG. 8 show the cyclic nature of the steps. The illustrations of FIG. 8 shown that the steps of stage 300 may be understood as splitting of one logical qubit into two logical qubits with a known logical ZZ-parity (e.g., indicted by the line connecting the data qubits around the boundary of the calibration group or the boundaries between the two logical qubits). This logical-ZZ parity may be employed to detect logical X errors in one of the two logical qubits during the second step 804, the third step 806, and/or the fourth step 808. The first step 802 and the fifth step 810 may be interpreted as the same steps due to the cyclic nature of the steps.

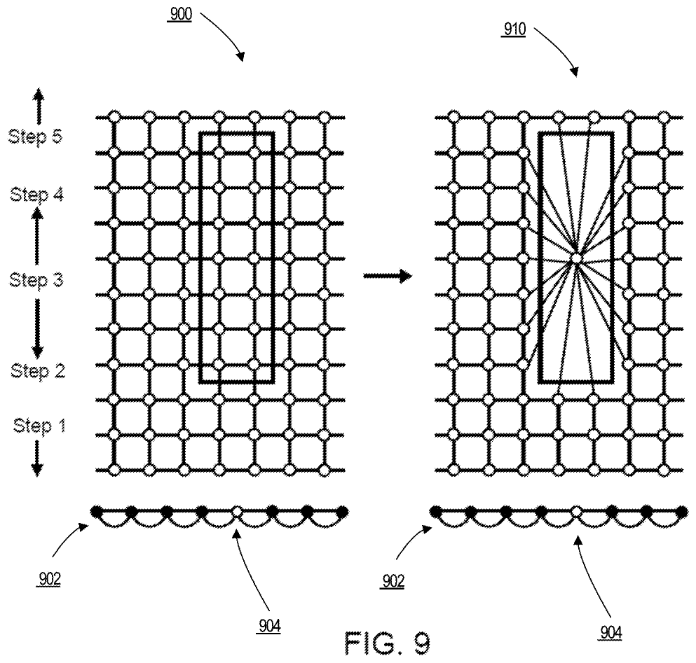

FIG. 9 depicts a visualization of decoding a quantum error detection code, according to various embodiments. More particularly, the QEC code shown in FIG. 1 is a 1D code that detects bit-flip errors (e.g., X errors). Accordingly, the parity checks in the 1D code include Z stabilizers. Although the code is only a 1D code for X-errors only, the decoding demonstrated in FIG. 9 may be generalized to 2D codes (e.g., a surface code) that check (and correct) both X errors and Z errors (e.g., phase-flip errors).

FIG. 9 shows a first decoding graph 900 and a modified decoding graph 910. The horizontal lines of open circles (or dots) represent a 1D code of qubits subject to Z parity checks. The vertical axis represents temporal steps, with previous times lower on the graphs. The 1D code 902 is shown below each of the graphs. Five steps corresponding to the steps of FIGS. 3-8 are labeled. The calibration region is shown by the rectangle between steps 2-5 on the two graph. The calibration qubit 904 is shown by the open circle on the 1D code 902. The first decoding graph 900 represents a 1D logical qubit, prior to splitting due to a calibration cycle. The modified decoding graph 910 shows the decoding with a calibration qubit 904 removed from the logical qubit and the merging of the two pieces of the logical qubit being merged back together via the lattice surgery techniques discussed throughout.

That is, the modified decoding graph 910 shows the modification required to decode a logical qubit that has been split into two pieces to allow for the calibration qubit 904 to be taken “offline” and calibrated during a quantum computation. In the embodiments, multiple Z-check syndrome measurements are performed over many cycles via the original decoding graph 900. For steps 2-4, each of the Z-detectors are fused together for the overlap region into a single detector, as shown via the modified decoding graph 910. This allows for a comparison of the persistent Z-check between steps 1-5.

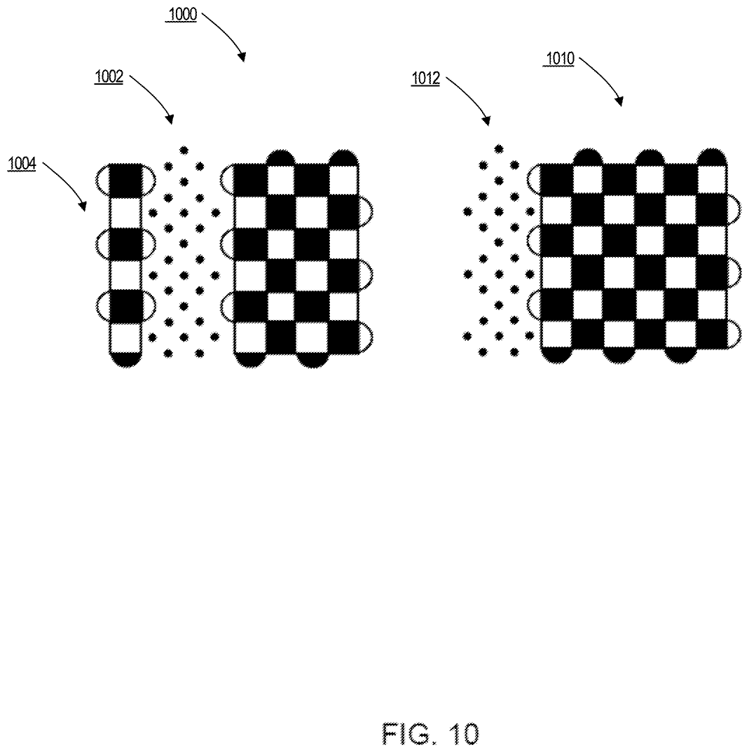

FIG. 10 depicts a selection of a calibration group near the boundary of a logical qubit, according to various embodiments. More particularly, FIG. 10 shows a first scenario 1000 that has selected a first calibration group 1002 near the boundary of a logical qubit. However, this selection leaves a narrow strip 1004 of tiles on the boundary of the logical qubit that are included in the computation group. FIG. 10 also shows a second scenario 1010, where the selection of a second calibration group 1012 is on the border of the logical qubit, and does not leave a narrow strip of qubits on the logical qubit boundary that are included in the computation group. In various embodiments, when calibrating qubits near a boundary of the logical qubits, a thin band of qubits in the calibration group (e.g., the narrow strip 1004) may not be useful. Accordingly, it may be more advantageous to extend the calibration region to the edge, as shown in the second scenario 1010

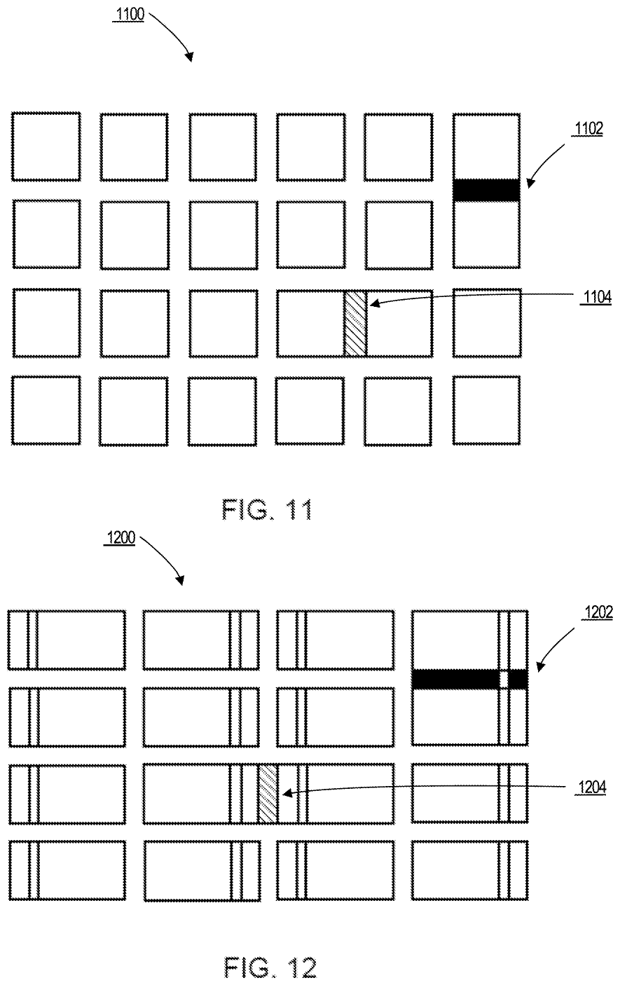

FIG. 11 depicts a computing with lattice surgery, according to various embodiments. More particularly, FIG. 11 depicts a 2D grid 1100 (or lattice) of logical qubits. Fault tolerant computing may be implemented by employing the 2D grid 1100 of logical qubits in a surface code, via lattice surgery. Adjacent logical qubits in the 2D grid 1100 share common boundaries. Lattice surgery operations follow the orientation of the common boundaries on the surface-code patches (e.g., logical qubits). A logical XX-check 1002 may be performed between vertically adjacent pairs of logical qubits. A logical ZZ-check 1104 may be performed between horizontally adjacent pairs of logical qubits.

FIG. 12 depicts lattice surgery between adjacent pairs of logical qubits computing with lattice surgery, according to various embodiments. Similar to the 2D grid 1100 of logical qubits of FIG. 11, FIG. 12 shows a 2D grid 1200 of logical qubits. A calibration process similar to process 200 of FIG. 2 is being performed on the logical qubits of the 2D grid 1200. The current calibration group is shown via the vertical bands in the logical qubits. That is, FIG. 12, shows a performance of a quantum computation with both lattice surgery and continuous calibration of the qubits forming the logical qubits. The calibration process may be synchronized across the 2D grid 1200 of logical qubits. More particularly, the calibration schedules may be synchronized so that columns of calibration groups are aligned, as shown in FIG. 12. By aligning the columns of calibration groups, the XX-checks of the lattice surgery (e.g., XX-check 1202) are enabled. Check 1204 is a ZZ check. Note that the order of calibration groups may be mirrored in alternating columns.

### Example Methods

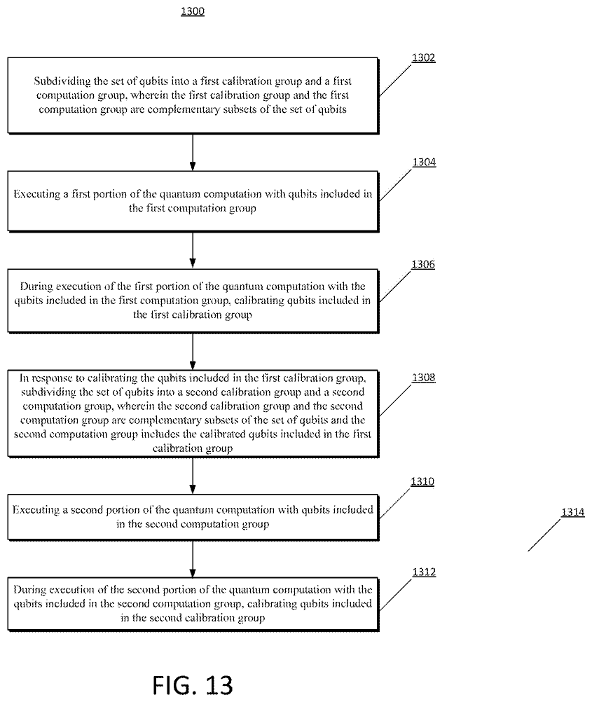

FIG. 13 depicts a flow chart diagram of an example method 1300 performing a quantum computation, while calibrating qubits, according to example embodiments of the present disclosure. The set of qubits may be allocated for the quantum computation. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 1302, the set of qubits may be into a first calibration group and a first computation group. The first calibration group and the first computation group may be complementary subsets of the set of qubits. At block 1304, a first portion of the quantum computation may be executed with qubits included in the first computation group. At block 1306, and during execution of the first portion of the quantum computation with the qubits included in the first computation group, qubits included in the first calibration group may be calibrated. At block 1308, and in response to calibrating the qubits included in the first calibration group, the set of qubits may be subdivided into a second calibration group and a second computation group. The second calibration group and the second computation group may be complementary subsets of the set of qubits. The second computation group may include the calibrated qubits included in the first calibration group. At block 1310, a second portion of the quantum computation may be executed with qubits included in the second computation group. At block 1312, and during execution of the second portion of the quantum computation with the qubits included in the second computation group, qubits included in the second calibration group may be calibrated.

In various embodiments, during the execution of the first portion of the quantum computation, the qubits of the first computation group form a first logical qubit of a quantum error correction (QEC) code. During the execution of the second portion of the quantum computation, the qubits of the first calibration group are included in the first logical qubit of the QEC code. The QEC code may be a surface code. In at least some embodiments, a portion of the qubits included in the first computation group are included in the second calibration group and the calibrated qubits included in the first calibration group are included in the second computation group. In other embodiments, during the execution of the first portion of the quantum computation, the qubits of the first computation group form a first logical qubit of a surface code. During the execution of the second portion of the quantum computation, the qubits of the second computation group form the first logical qubit of the surface code.

Subdividing the set of qubits into the first calibration group and the first computation group may include subdividing the set of qubits into N non-overlapping subsets of qubits to form a set of qubit groups, where N is a positive integer greater than one. The subdivided set of qubit groups may include the set of qubit groups. Each qubit group of the set of qubit groups includes one of the N non-overlapping subsets of qubits. A first qubit group of the set of qubit groups may be selected as the first calibration group such that the set of qubit groups comprises the first calibration group and a set of current computation groups that comprises the other (N−1) non-selection qubit groups of the set of qubit groups. The set of current computation groups excludes the first calibration group and forms the first computation group.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for performing a quantum computation, wherein a set of qubits is allocated for the quantum computation, the method comprising:
subdividing the set of qubits into a first calibration group and a first computation group, wherein the first calibration group and the first computation group are complementary subsets of the set of qubits;
executing a first portion of the quantum computation with qubits included in the first computation group; and
during execution of the first portion of the quantum computation with the qubits included in the first computation group, calibrating qubits included in the first calibration group; and
executing a second portion of the quantum computation with the calibrated qubits included in the first calibration group.

2. The method of claim 1, wherein during the execution of the first portion of the quantum computation, the qubits of the first computation group form a first logical qubit of a quantum error correction (QEC) code, and wherein during the execution of the second portion of the quantum computation, the qubits of the first calibration group are included in the first logical qubit of the QEC code.

3. The method of claim 2, wherein the QEC code is a surface code.

4. The method of claim 1, further comprising:
in response to calibrating the qubits included in the first calibration group, subdividing the set of qubits into a second calibration group and a second computation group, wherein the second calibration group and the second computation group are complementary subsets of the set of qubits and the second computation group includes the calibrated qubits included in the first calibration group;
executing the second portion of the quantum computation with qubits included in the second computation group; and
during execution of the second portion of the quantum computation with the qubits included in the second computation group, calibrating qubits included in the second calibration group.

5. The method of claim 4, wherein a portion of the qubits included in the first computation group are included in the second calibration group and the calibrated qubits included in the first calibration group are included in the second computation group.

6. The method of claim 4, wherein during the execution of the first portion of the quantum computation, the qubits of the first computation group form a first logical qubit of a surface code, and wherein during the execution of the second portion of the quantum computation, the qubits of the second computation group form the first logical qubit of the surface code.

7. The method of claim 1, wherein subdividing the set of qubits into the first calibration group and the first computation group comprises:
subdividing the set of qubits into N non-overlapping subsets of qubits to form a set of qubit groups, wherein N is a positive integer greater than one, the subdivided set of qubit groups comprises the set of qubit groups, and each qubit group of the set of qubit groups includes one of the N non-overlapping subsets of qubits; and
selecting a first qubit group of the set of qubit groups as the first calibration group such that the set of qubit groups comprises the first calibration group and a set of current computation groups that comprises the other (N−1) non-selection qubit groups of the set of qubit groups, wherein the set of current computation groups excludes the first calibration group and forms the first computation group.

8. A quantum computing system, comprising:
a quantum processor that includes a set of qubits;
one or more memory devices, the one or more memory devices storing computer-readable instructions that when executed by the one or more processors cause the one or more processors to perform operations for characterizing the QLC, the operations comprising:
subdividing the set of qubits into a first calibration group and a first computation group, wherein the first calibration group and the first computation group are complementary subsets of the set of qubits;
executing a first portion of the quantum computation with qubits included in the first computation group; and
during execution of the first portion of the quantum computation with the qubits included in the first computation group, calibrating qubits included in the first calibration group; and
executing a second portion of the quantum computation with the calibrated qubits included in the first calibration group.

9. The system of claim 8, wherein during the execution of the first portion of the quantum computation, the qubits of the first computation group form a first logical qubit of a quantum error correction (QEC) code, and wherein during the execution of the second portion of the quantum computation, the qubits of the first calibration group are included in the first logical qubit of the QEC code.

10. The system of claim 9, wherein the QEC code is a surface code.

11. The system of claim 8, wherein the operations further comprise:
in response to calibrating the qubits included in the first calibration group, subdividing the set of qubits into a second calibration group and a second computation group, wherein the second calibration group and the second computation group are complementary subsets of the set of qubits and the second computation group includes the calibrated qubits included in the first calibration group;
executing the second portion of the quantum computation with qubits included in the second computation group; and
during execution of the second portion of the quantum computation with the qubits included in the second computation group, calibrating qubits included in the second calibration group.

12. The system of claim 11, wherein a portion of the qubits included in the first computation group are included in the second calibration group and the calibrated qubits included in the first calibration group are included in the second computation group.

13. The system of claim 11, wherein during the execution of the first portion of the quantum computation, the qubits of the first computation group form a first logical qubit of a surface code, and wherein during the execution of the second portion of the quantum computation, the qubits of the second computation group form the first logical qubit of the surface code.

14. The system of claim 8, wherein subdividing the set of qubits into the first calibration group and the first computation group comprises:
subdividing the set of qubits into N non-overlapping subsets of qubits to form a set of qubit groups, wherein N is a positive integer greater than one, the subdivided set of qubit groups comprises the set of qubit groups, and each qubit group of the set of qubit groups includes one of the N non-overlapping subsets of qubits; and
selecting a first qubit group of the set of qubit groups as the first calibration group such that the set of qubit groups comprises the first calibration group and a set of current computation groups that comprises the other (N−1) non-selection qubit groups of the set of qubit groups, wherein the set of current computation groups excludes the first calibration group and forms the first computation group.

15. One or more non-transitory computer-readable media that store instructions that, when executed by one or more processors, cause the one or more quantum processors including a set of qubits to perform operations comprising:
subdividing the set of qubits into a first calibration group and a first computation group, wherein the first calibration group and the first computation group are complementary subsets of the set of qubits;
executing a first portion of the quantum computation with qubits included in the first computation group; and
during execution of the first portion of the quantum computation with the qubits included in the first computation group, calibrating qubits included in the first calibration group; and
executing a second portion of the quantum computation with the calibrated qubits included in the first calibration group.

16. The computer readable media of claim 15, wherein during the execution of the first portion of the quantum computation, the qubits of the first computation group form a first logical qubit of a quantum error correction (QEC) code, and wherein during the execution of the second portion of the quantum computation, the qubits of the first calibration group are included in the first logical qubit of the QEC code.

17. The computer readable media of claim 15, wherein the operations further comprise:
in response to calibrating the qubits included in the first calibration group, subdividing the set of qubits into a second calibration group and a second computation group, wherein the second calibration group and the second computation group are complementary subsets of the set of qubits and the second computation group includes the calibrated qubits included in the first calibration group;
executing the second portion of the quantum computation with qubits included in the second computation group; and
during execution of the second portion of the quantum computation with the qubits included in the second computation group, calibrating qubits included in the second calibration group.

18. The computer readable media of claim 17, wherein a portion of the qubits included in the first computation group are included in the second calibration group and the calibrated qubits included in the first calibration group are included in the second computation group.

19. The computer readable media of claim 17, wherein during the execution of the first portion of the quantum computation, the qubits of the first computation group form a first logical qubit of a surface code, and wherein during the execution of the second portion of the quantum computation, the qubits of the second computation group form the first logical qubit of the surface code.

20. The computer readable media of claim 15, wherein subdividing the set of qubits into the first calibration group and the first computation group comprises:
subdividing the set of qubits into N non-overlapping subsets of qubits to form a set of qubit groups, wherein N is a positive integer greater than one, the subdivided set of qubit groups comprises the set of qubit groups, and each qubit group of the set of qubit groups includes one of the N non-overlapping subsets of qubits; and
selecting a first qubit group of the set of qubit groups as the first calibration group such that the set of qubit groups comprises the first calibration group and a set of current computation groups that comprises the other (N−1) non-selection qubit groups of the set of qubit groups, wherein the set of current computation groups excludes the first calibration group and forms the first computation group.
